(19) United States
(12) Patent Application Publication
(10) Pub. No.: US 2002/0061374 A1
(43) Pub. Date: May 23, 2002

(54) COMPOSITE TUBULAR MEMBER HAVING IMPACT RESISTANT MEMBER

(76) Inventors: FRANK O'BRIEN, EAST FALMOUTH, MA (US); PETER A. QUIGLEY, POCASSET, MA (US); STEPHEN C. NOLET, FRANKLIN, MA (US)

Correspondence Address: LAHIVE & COCKFIELD, 28 STATE STREET, BOSTON, MA, 02109, US

(21) Appl. No.: 09/239,897

(22) Filed: Jan. 29, 1999

(51) Int. Cl. B32B 1/08

(52) U.S. Cl. 428/36.9; 428/35.7

(57) ABSTRACT

An axially extending tubular composite member having a plurality of plies and extending along a longitudinal axis has at least three plies with selectively structured fiber components in each ply and an internal impact resistant beam having a C-shaped or U-shaped cross section positioned between two of the plies. Typically an inner ply has at least one biaxial fiber component, an intermediate ply has at least an axial fiber component that typically is combined with two further fibers to form a triaxial fiber component. Another ply typically has a woven fiber component. A further ply having a biaxial component either replaces the ply of woven fiber or is disposed beneath it over the intermediate ply. A surface veil having fiber and an excess of resin material typically covers at least the innermost or outermost surface of the composite member. The impact resistant member is constructed from an impact resistant material such as ABS plastic, and is typically positioned between the intermediate ply and the exterior ply.

### BACKGROUND

This invention provides resin-fiber composite tubular members having unique combinations of fiber orientations in different plies, and having selected other reinforcement.

The composite members of the invention are advantageously used in various manufactured products, including sports implements such as golf clubs and hockey sticks among others.

Sports implements have long been made with various materials including wood and particularly wood shafts. Wood implements can have high strength as desired and can have a satisfying feel for the user. One drawback of wood, however, is significant variation from item to item, even when made to the same specifications and dimensions.

Moreover, the composite tubular shafts of the prior art can present significant danger to the user because of insufficient impact resistance and strength. Sporting records are constantly broken; and as the limits of physical achievement increase, the demands for integrity and longevity in the strength and resistance of the shaft also increases. Presently, tubular shafts fail during the ordinary course of play because they cannot withstand the variety of forces exerted on them, particularly damage transverse to the length of the shaft as in a hockey stick slash. Once a tubular shaft fails, it may project sharp or splintered edges that can cut or seriously injure the athletes.

Among the known practices regarding fiber-reinforced resin tubular materials are the bicycle frame structure disclosed in U.S. Pat. No. 4,657,795 of Foret. Also in the prior art are U.S. Pat. Nos. 5,048,441; 5,188,872; and No. RE 35,081.

One object of this invention is to provide composite tubular members suited for the shaft of a sports implement. Other objects of the invention will in part be obvious and will in part appear hereinafter.

### SUMMARY OF THE INVENTION

The tubular members which the invention provides have resin-fiber composite construction with improvements in durability and particularly in impact strength. Further, the tubular members are generally suited for relatively low cost manufacture.

The tubular members of the invention have one or more plies of fibers and include an impact resistant member for increasing the impact resistance of the tubular members by inhibiting fracture or shattering of the tubular members when subjected to an impact, especially in a direction transverse to the longitudinal axis of the tubular members. In one practice, the multiple-ply composite members can be constructed with structures and according to manufacture methods described in U.S. Pat. No. 5,549,947, incorporated herein by reference.

Typically, an axially extending tubular composite member according to the invention has a plurality of plies, including, for example, at least one interior ply having a fiber component within a matrix material and at least one exterior ply having a fiber component within the matrix material. The impact resistant member is can be positioned between the exterior ply and the interior ply of fibers and embedded within the matrix material.

Alternatively, the impact resistant member can be positioned interior to the interior ply or exterior to the exterior ply. Positioning the impact resistant member interior to the interior ply may be preferable as the force of an impact on the exterior ply of the tubular member can resonates internally through the cross section of the tubular member resulting in increased damage to the interior ply.

The impact resistant member is applicable in structures having any of various cross sections, examples of which include a polygonal cross section and a circular cross section. For example, in a structure having a polygonal cross section, the impact resistant member is preferably an elongated beam member having a U-shaped or C-shaped concave cross section and extends along at least a portion of the length of the member, essentially parallel to the axis or length of the member. Such a beam member is preferably provided within each of two opposed walls. The pair of beam members are preferably coextensive along the length of the tubular member. In a structure having a rectangular cross section, the impact resistant beam members preferably extends between two opposed walls. In a structure having an internal reinforcing member such as a web member, the internal reinforcing member preferably extends between the opposed walls that include the impact resistant beam members. Preferably, the longitudinally-extending edges or the corner radii of the impact resistant beam members have a greater thickness than the middle portion of the member.

The impact resistant member can extend along the full length of the tubular member or along only part of the length. The latter may be used, for example, to decrease weight and to control stiffness. The impact resistant member can include a plurality of cut-outs or perforations along its length to further reduce the weight of the impact resistant member.

The material forming the impact resistant member is preferably constructed from acrylonitrile-butadiene-styrene (ABS) plastic. Alternatively, materials can include thermoplatsic and thermoset materials, metal alloys, and other materials suitable for providing increased impact resistance to the composite tubular member without substantially increasing the weight of the tubular member or altering the bending characteristics of the tubular member.

In one preferred practice, the impact resistant member is fabricated and added to the composite member during the manufacturing process of the composite member by inserting the impact resistant member over one of the interior plies of fibers. An exterior ply can then be applied over the impact resistant member. The impact resistant member preferably is added prior to final curing of the polymers of the composite member to ensure a solid attachment of impact resistant member to the composite member. Alternatively, the impact resistant member can be added in a secondary manufacturing step, for example by bonding or mechanical coupling to one of the interior or exterior plies.

The tubular composite member generally has at least three plies, including an inner or interior ply that commonly has at least one biaxial fiber component embedded in the matrix material. As used herein a biaxially fiber component includes two sets of fibers or threads spirally wrapping in opposite directions about the axially extending composite member. The two sets of fibers thus are generally symmetrical and generally extend diagonally relative to the axis of the member.

An intermediate ply of the composite member typically has at least one axially extending fiber component also disposed with the resin or other matrix material. The intermediate ply is disposed contiguously over the interior ply and hence is exterior to the interior ply. The axial fiber component of the intermediate ply can be a substantially continuous set of fibers extending essentially parallel to the elongation axis of the composite member. Alternatively, a set of axially extending fibers can follow a helical path, i.e., extend at an acute angle relative to the elongation axis. In one practice the axial fiber is interlaced with two other sets of threads or fibers extending symmetrically in opposite directions relative to the axial fiber, to constitute so-called triaxial fiber structure. The interlacing or diagonally extending sets of fibers enhance maintaining the axially extending fibers in place and they add strength, including preventing cracks and other stress failures or fractures from propagating.

In one practice of the invention a further ply overlying the intermediate ply has a woven fiber component. In a typical embodiment, the woven fiber component has the two sets of fibers, and one is oriented axially and the other transversely relative to the longitudinal axis, i.e., a so-called 0° and 90° fiber orientation relative to the elongation axis.

A further practice of the invention employs an outer ply having at least one biaxial fiber component and located over the intermediate ply and either in place of a woven fiber component as described above or beneath such a woven fiber component.

Aside from applying fiber components in woven form, they can be formed with continuous fiber strands drawn from spools as described in U.S. Pat. No. 5,549,947. Alternatives include applying the fibers in preformed fibrous sheets. Alternatively, the fibers can be braided, stitched or knitted.

It is also to be understood that each ply can include two or more subplies. By way of example, the inner ply of a tubular member according to the invention can have two subplies, each with a biaxial fiber component. In a further example, the biaxial fibers can have different fiber angles, relative to the elongation axis, in the two subplies.

A typical further element of a composite member according to the invention is a surface veil, forming either the extreme outer surface of the member or the extreme tubular inner surface, or both. Such a surface veil can facilitate the manufacture of the member, particularly in a pultrusion manufacture. An exterior veil can enhance appearance, an interior veil can improve impact resistance. As is known in the art, a surface veil for these purposes has a relatively large proportion of resin and a relatively lesser fiber component.

The fibers of a composite member according to the invention are generally selected, using known criteria, from materials including carbon, aramid, glass, linear polyethylene, polyethylene, polyester, and mixtures thereof.

The matrix material is selected from a group of resin-based materials, such as thermoplastics and thermosets. Examples of thermoplastics include: polyetherether-ketone, polyphenylene sulfide, polyethylene, polypropylene, and Nylon-6. Examples of thermosets include: urethanes, epoxy, vinylester, and polyester.

In a further practice of the invention, tubular members having a resin-fiber composite structure have improvements in durability and particularly in impact strength, and yet retain light weight, when constructed with one or more additional structural elements. Such structural elements which the invention provides include selectively concave walls, selected added thickness at corners of walls, added thickness selectively in each of two opposed walls, and internal reinforcement.

The first three features stated above, i.e., concave walls, thickened comers, and thickened walls, are applicable to members having a non-circular cross section and typically to members having a polygonal cross-section. A preferred polygonal cross-section has four or more sides.

The foregoing structural features preferably are used in combination with one another, such as opposed concave walls combined with added wall thickness at the corners of those walls, or added thickness at opposed walls and added thickness at the corners of those walls.

The internal reinforcement is applicable in structures having any of various cross sections, examples of which include a polygonal cross section and a circular cross section. Examples of such reinforcement include an interior rib extending along at least a portion of the length of the member, either essentially parallel to the axis or length of the member or selectively angled, e.g., helical, with regard to the axis of a straight member. Such a rib is preferably provided on each of two opposed walls. Another example of such internal reinforcement is an interior web, or an axially spaced succession of interior braces, spanning between opposed walls or between adjacent walls. For example, an interior web or brace in a composite tubular member according to one embodiment of the invention and having a circular or elliptical cross section can follow the path of a chord extending between two locations spaced apart around the circumference of the composite member, when viewed in cross section. Correspondingly, in a structure having a polygonal cross section, the internal web or brace extends between adjacent walls. Further examples include such braces or webs extending between opposed walls or wall portions, including along the path of a diameter of a member having a circular or elliptical cross section.

The interior reinforcement can extend along the full length of the member or along only part of the length. The latter may be preferred, for example, to decrease weight and to control stiffness.

In one preferred practice, the internal reinforcement is formed during the initial pultrusion fabrication of the composite member and accordingly is continuous along the length of the member, or at least along a selected portion thereof. Where such an internal reinforcing web is formed continuously along the length of a member, it can subsequently be removed, as by machining, from one or more selected portions of the length of the member. This may be desired to reduce the weight of the member.

A further alternative is to fabricate the composite member and add internal reinforcement, by inserting a preformed internal reinforcement element. The internal reinforcement element preferably is added prior to final curing of the polymers of the composite member and of the reinforcement element to ensure a solid attachment of the internal reinforcement member element to the composite member. In accordance with another method of fabrication, the composite member and the internal reinforcing element are formed concurrently as part of a resin transfer or compression molding process. This fabrication method provides a system capable of forming a composite member integral with an internal reinforcing element, both having selective characteristics along the length of the member.

The invention accordingly comprises an article of manufacture possessing features, properties and relations of elements exemplified in the articles hereinafter described, and comprises the several steps and the relation of one or more of such steps with respect to each of the others for fabricating such articles, and the scope of the invention is indicated in the claims.

### BRIEF DESCRIPTION OF THE DRAWINGS

For a fuller understanding of the nature and objects of the invention, reference is to be made to the following detailed description and the accompanying drawing, in which:

FIG. 1 shows a transverse cross-section and longitudinal fragment of a composite tubular member according to one practice of the invention;

FIG. 2 shows a transverse cross-section of the composite tubular member of FIG. 1;

FIG. 3 shows a transverse cross-section and longitudinal fragment of a composite tubular member according to another practice of the invention; and

FIG. 4 shows a sports implements, namely, a hockey stick utilizing shafts according to the invention.

### DESCRIPTION OF ILLUSTRATED EMBODIMENTS

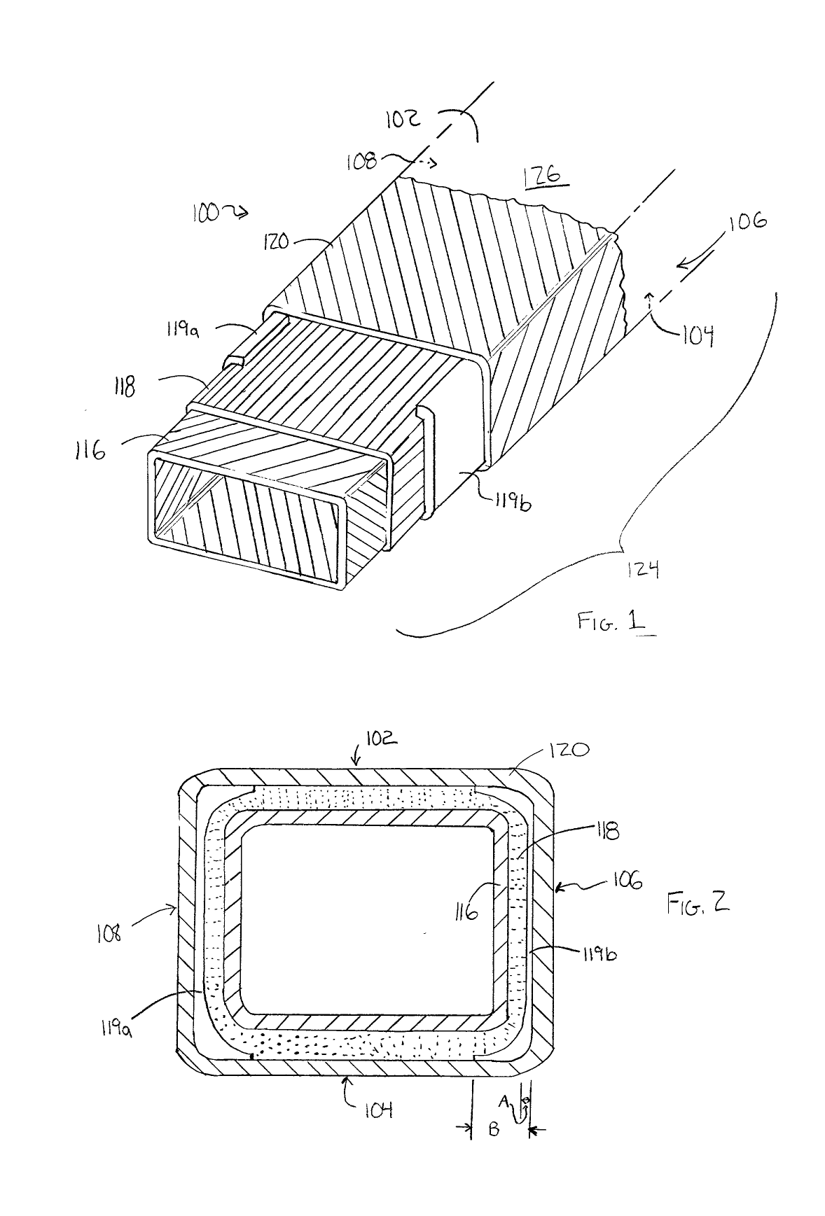

FIG. 1 shows a transverse cross section and longitudinal fragment of a composite tubular member 100 according to one preferred practice of the invention. The illustrated member 100 has a rectangular cross section with two wide opposed walls 102 and 104 and two narrow opposed walls 106 and 108. The tubular member 100 for example, the shaft of a hockey stick or of a lacrosse stick and can be constructed essentially as described in U.S. Pat. No. 5,549,947. Each wall 102, 104, 106 and 108 of the illustrated member 100 has generally uniform thickness along the length of the member and the four walls are of essentially the same thickness. Thus, the illustrated member 100 is preferably continuous along at least a selected length, i.e., has the same cross section at successive locations along that selected length. This continuous cross sectional configuration facilitates manufacture, for example with pultrusion procedures as described in U.S. Pat. No. 5,549,947. Composite tubular members constructed in this manner are described in detail in U.S. Pat. No. 5,688,571 and co-pending, commonly assigned U.S. patent application Ser. No. 08/680,349, each of which is incorporated herein by reference.

Referring to FIGS. 1 and 2, the member 100 includes an elongated strip of fabric 116 forming an inner ply. A ply 118 of axially-extending fibers is then disposed over the layer formed by the fabric 116. A pair of generally longitudinally extending beams 119a,b of C-shaped or U-shaped cross section are positioned over the intermediate ply 118 (and the inner ply 116). Another elongated strip of fabric 120 is formed into a closed tube enclosing the beams 119a,b (and the structure therein formed by the plies 118 and 116).

The foregoing assemblage of fiber plies is impregnated with resin 124, typically an epoxy resin, and the resultant composite is cured.

The foregoing procedure of fabricating the member 100 can be practiced in a pultrusion system with a fixed, i.e., stationary, mandrel on which the fabric and fiber layers are formed, and within an outer die-like forming member. Alternatively, the member 100 can be fabricated through a resin transfer molding process.

In one preferred embodiment, the fabric 116 is a preformed fabric, preferably non-woven, i.e., of stitched or knitted structure, with fibers oriented at ± forty-five degrees relative to the longitudinal axis of the member 100. Alternatively, braided or woven fabrics oriented at ± forty-five degrees relative to the longitudinal axis of the member 100 may be used. Such a fabric 116 thus forms an inner ply of the member 100 and which has a biaxial fiber component. The fabric 116 can be, for example, of glass, carbon or aramid fibers.

The fibers in the ply 118 can be of carbon or of glass, or can be a hybrid, i.e., a combination of glass and of carbon, by way of example. These fibers form the ply 118 as an intermediate ply in the member 100 and with at least an axial fiber component.

The longitudinally extending beams 119a,b are preferably provided in pairs, as shown in FIGS. 1 and 2. In the illustrative embodiment, the beams 119a,b are disposed in opposite side walls 106 and 108, respectively, of the member 100, and extend between the opposed side walls 102 and 104, as shown in FIGS. 1 and 2. In cross section, the beams 119a,b extend about only a fraction or a portion of the circumference of the tubular member 100. The concavity of the beams 119a,b preferably is symmetrical, as shown.

In the illustrative member 100, the beams 119a,b are disposed between the intermediate plies 118 and the exterior ply 120. The beams 119a,b are not, however, limited to this particular location, but can be disposed over or within any of the plies or layers of the composite tubular member 110, including, for example, within the inner ply 116 or over the exterior ply 120.

Each impact resistant member 119a,b of the illustrated member 100 is an elongated beam generally of increased thickness in the comers, and with a C- or U-shaped cross section, as shown in FIGS. 1 and 2. In the illustrated composite member 100, the inner surfaces of the beams 119a,b have a radius to create an increased thickness in the corners of the beams 119a,b. One preferred magnitude of the difference in wall thickness is in accord with Equation 1 below, where the dimension (A) is the minimal thickness of a cap 119, e.g., at its midpoint, and the dimension (B) is the thickness of that wall as measured in the same direction, at one corner thereof.

B≧1.05A (Eq. 1)

The beams 119a,b are preferably constructed of a material having high impact strength, such as acrylonitrile-butadiene-styrene (ABS) plastic. The beams 119a,b of impact resistant material thus form the impact resistant members of the member 100. Generally, ABS plastic is a thermoplastic produced by grafting styrene and acrylonitrile onto a diene-rubber backbone that provides a balance of impact resistance, hardness, tensile strength, and elastic modulus particularly suited for inhibiting fracturing or shattering of a composite tubular member due to an impact.

Materials alternative to ABS plastic can also be used to form the beams 119a,b that provide high impact resistance without substantially increasing the weight of the tubular composite member and without adversely affecting the bending characteristics of the member. Suitable materials for the beams 119a,b include, for example, thermoplastic materials, such as polyamide, polyethylene, and polypropylene, thermoset materials, such as urethanes and epoxies, elastomeric materials, such as rubbers and silicones, composite materials, such as fiber and particle filled thermosets and thermoplastics, and metallic materials.

Preferably, the material forming the beams 119a,b has a tensile strain to failure of at least 5%.

The illustrative ABS plastic beams 119a,b can be formed through injection molding processes or through extrusion and subsequent thermoforming into the desired concave shape. Suitable injection molding, extrusion, and thermoforming processes are well known in the art and need not be described herein in detail.

Preferably, the beams 119a,b , are preformed into the desired shape and disposed on or within a ply or layer of the composite tubular member 100 prior to injection of the resin 124 into the plies or layers. In this manner, the beams 119a,b are embedded in the resin 124 after the curing step. Alternatively, the beams 119a,b can be bonded to one of the layers or plies of the member 100 or secured by mechanical means, e.g. through compression between two of the plies or layers.

The fabric 120 in the illustrated embodiment is a preformed fabric of glass and/or carbon, preferably of non-woven structure and having fibers oriented at ± forty-five degrees relative to the member longitudinal axis. This fabric thus forms an outer ply of the member 100 and which also has a biaxial fiber component.

The primary function of each layer in the member 100 is that each fabric 116 and fabric 120 forms a ply providing torsional stiffness to the member 100. The axially-oriented fibers in the ply 118 provide bending load strength, i.e., axial stiffness to the member 100. The beams 119a,b, provide impact resistance.

The member 100 can be further formed, prior to curing, with one or more light gauze or surface veil plies 126 of preformed gauze or veil-like fiber that is highly resin-absorbent. These surface gauze or veil plies enhance the abrasion resistance of the member 100 and can provide an attractive surface finish.

More generally, the invention can be practiced, in one instance, with fibers oriented at angles other than those for the particular embodiment described above. For example, each fabric 116 and 120 can be arranged with fibers oriented between ±30° and ±60° relative to the longitudinal axis of the member 100. More preferred ranges of the fiber angles for each of these fabrics are between ±40° and ±50°. Further, in most practices of the invention, the two sets of fibers of each fabric—which generally are orthogonal to each other within the fabric—are oriented on the member symmetrically relative to the longitudinal axis of the member.

The longitudinal seams of the different strips of fabric that form the several plies of the member 100, as described above, are preferably formed at different, spaced apart locations in the member 100. For example, the longitudinal seams of the fabrics 116 and 120 can also be located along different walls of the member 100.

Features attained with a composite member having the structure described and shown are that it has high bending strength and stiffness, and high torsional rigidity. It also has, through the wall thickness, durability and impact resistance, e.g. it resists fracturing from a slash to the composite member as in hockey or lacrosse. Further by way of illustrative example and without limitation, a member 100 as described above and shown in FIG. 1 and suited for use as a hockey stick shaft can have a thickness in each wall 102, 104, 106 and 108 of approximately between 0.080 inches and 0.110 inches.

FIG. 3 shows another construction for a member 100′, which illustratively has a quadrilateral cross section transverse to an elongation axis, as shown. The member 100′ has an inner ply 116′ with a biaxial fiber component, an intermediate layer 118′ with an axial fiber component, and an external ply 120′ which illustratively also has a biaxial fiber component similar to the inner ply 116′. Further, each biaxial fiber component of the inner and outer plies 116′ and 120′ includes a stitching fiber 116A′ and 118A′. The foregoing fiber components of the member 100′ are embedded in a resin matrix that extends through all the plies to form the fiber components into a single unitary structure.

The member 100′ of FIG. 2 also includes an internal reinforcing rib 110 and a pair of elongated beams 119′a,b of U- or C-shaped cross section disposed between the intermediate ply 118′ and the exterior ply 120′. The reinforcing rib 110 and the concave beams 119′a,b are continuous along at least a selected portion of the length of the member 100′. Each of the beams 119′a,b include a plurality of cut-outs or perforations 130 along the length thereof to reduce the weight of the beams. Alternative means for providing internal reinforcement are described in copending U.S. patent application Ser. No. 08/680,349and may be used in place of the reinforcing rib 110.

A surface veil 126′ preferably is applied over the outer surface of the member 100′, as FIG. 2 further shows.

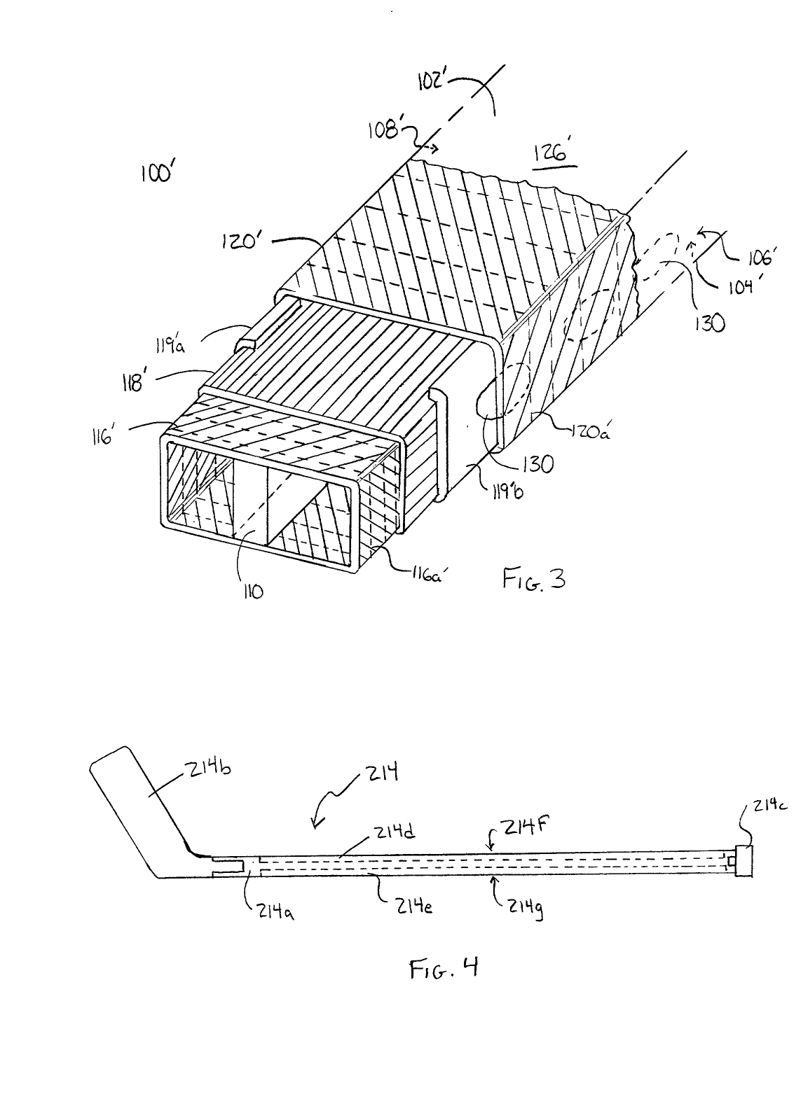

FIG. 4 illustrate a hockey stick 214 constructed with a shaft 214a, that is a tubular composite member of the type described above in FIGS. 1, 2, and 3.

In particular, the hockey stick 214 has a conventional blade 214b, secured at a lower end of the shaft 214a, and has an end cap 214c secured to the upper other end of the shaft 214a. The illustrated shaft 214a has a pair of elongated beams 214d,e as described above with reference to FIGS. 1, 2, and 3, extending for a substantial portion of the length of the shaft. The beams 214d,e are positioned on opposite side walls 214f and 214g of the shaft 214a. Preferably, at least one of the beams, i.e. beam 214d, is disposed on the side, i.e. narrow side 214f, of the shaft 214a from which the blade 214b extends. In one illustrative embodiment, the shaft 214a is approximately 48 inches in length and the beams 214d,e are approximately 44 inches in length. In this embodiment, the beams 214d,e are disposed substantially adjacent the end cap 214c and approximately 4 inches above the blade 214b.

The shaft 214a thus is axially elongated with a handle portion at one end. At the other end, the shaft has a socket-like receptacle or other structure for seating and thereby mounting a sports implement, such as the hockey blade 214b.

The beams or impact resistant members described above in connection with the illustrative embodiments shown in FIGS. 1-4, are not limited to tubular composite members having a substantially rectangular cross section, but can be used with composite tubular members having circular or polygonal cross sections, including the each of composite tubular members described in commonly assigned U.S. Pat. Nos. 5,549,947, 5,556,677, and 5,688,571, and described in copending, commonly assigned U.S. patent application Ser. No. 08/680,349. Each of the above-referenced patents and patent applications is incorporated herein by reference.

It will thus be seen that the invention attains the objects set forth above, among those made apparent from the preceding description, and since certain changes may be made in carrying out the above method and in the articles set forth without departing from the scope of the invention, it is intended that all matter contained in the above description or shown in the accompanying drawings be interpreted as illustrative and not in a limiting sense.

It is also to be understood that the following claims are intended to cover all generic and specific features of the invention described herein, and all statements of the scope of the invention which, as a matter of language, might be said to fall therebetween.

Having described the invention, what is claimed as new and secured by Letters Patent is:

1. An axially extending tubular composite member extending along a longitudinal axis, said tubular composite member comprising
at least one interior ply having a fiber component within a matrix material,
at least one exterior ply having a fiber component within said matrix material, said exterior ply being exterior to said interior ply, and
an impact resistant member constructed from an impact resistant material and extending along at least a portion of the tubular composite member to inhibit fracture of said tubular composite member.

2. The tubular composite member of claim 1, wherein said impact resistant material is acrylonitrile-butadiene-styrene (ABS) plastic.

3. The tubular composite member of claim 1, wherein said impact resistant material is selected from the group consisting of thermoplastic and thermoset materials.

4. The tubular composite member of claim 1, wherein said impact resistant member is embedded within said matrix material.

5. The tubular composite member of claim 1, wherein said impact resistant member is a beam having generally U-shaped or C-shaped cross section.

6. The tubular composite member of claim 1, wherein said tubular composite member has a cross section transverse to said longitudinal axis in the form of a closed plane figure having at least four sides, and with at least two opposed wall portions.

7. The tubular composite member of claim 6, wherein said impact resistant member extends between said two opposed wall portions.

8. The tubular composite member of claim 6, further comprising a second impact resistant member positioned between said interior ply and said exterior ply and extending between said two opposed wall portions, said second impact resistant member being positioned opposite said impact resistant member.

9. A tubular composite member of claim 8, wherein said impact resistant member and said second impact resistant member are symmetrically concave beams extending along the longitudinal axis of the composite member.

10. The tubular composite member of claim 1, wherein said impact resistant member has a first medial thickness and have a greater thickness than said first thickness at longitudinally-extending edges thereof.

11. The tubular composite member of claim 1, wherein said impact resistant member extends along said longitudinal axis of the tubular composite member.

12. The tubular composite member of claim 1, further comprising an internal web-like reinforcement spanning across the tubular interior of the tubular composite member between and secured to two spaced apart wall portions.

13. The tubular composite member of claim 1, further comprising a veil covering said exterior ply, said veil including said matrix material.

14. The tubular composite member of claim 1, wherein said fiber component of said at least one interior ply includes at least a biaxial fiber component.

15. The tubular composite member of claim 1, wherein said fiber component of said at least one exterior ply includes a biaxial fiber component.

16. The tubular composite member of claim 1, further comprising at least one intermediate ply having at least one axially extending fiber component disposed within said matrix material, said intermediate ply being exterior to said interior ply.

17. The tubular composite member of claim 1, wherein the fiber materials of said biaxial fiber component and of said axial fiber component are selected from the group of fiber materials consisting of polyester, glass, carbon, aramid, and mixtures thereof.

18. The tubular composite member of claim 1, wherein said impact resistant member is positioned between said interior ply and said exterior ply.

19. The tubular composite member of claim 1, wherein said impact resistant member is positioned interior to said interior ply.

20. The tubular composite member of claim 1, wherein said impact resistant member is positioned exterior to said exterior ply.

21. An axially extending tubular composite member having a plurality of plies and having primary bending stiffness along a longitudinal axis, said tubular composite member having the improvement comprising
A. at least one interior ply having at least a biaxial fiber component with a matrix material,
B. at least one intermediate ply having at least one axially extending fiber component disposed within said matrix material, said intermediate ply being exterior to said interior ply,
C. at least one exterior ply having at least a biaxial fiber component disposed with said matrix material, said exterior ply being located exterior to said intermediate ply;
D. an impact resistant member constructed from an impact resistant material and positioned between said interior ply and said exterior ply to inhibit fracture of said tubular composite member.

22. The tubular composite member of claim 21, further comprising an internal web-like reinforcement spanning across the tubular interior of the tubular composite member between and secured to two spaced apart wall portions.

23. The tubular composite member of claim 21, wherein said impact resistant member is a first longitudinally extending beam of C-shaped or U-shaped cross section.

24. The tubular composite member of claim 23, further comprising a second impact resistant member, wherein said second impact resistant member is a second longitudinally extending beam of C-shaped or U-shaped cross section disposed in an opposite side wall of said tubular member from said first longitudinally extending beam.

25. In a method of manufacturing a composite tubular member having at least one ply of fibers in a matrix material, the improvement comprising the step of
providing first and second opposed beam members of C-shaped or U-shaped cross section in opposed wall segments of the tubular member.
